(19) United States
(12) Patent Application Publication
(10) Pub. No.: US 2006/0095314 A1
(43) Pub. Date: May 4, 2006

(54) Method for approving a new supplier

(76) Inventors: Tien-Chieh Wu, Taipei City (TW); Jia-Shyang Chou, Hsinchu City (TW); Shih-Tou Wu, Jhunan Township (TW)

Correspondence Address: RABIN & BERDO, P.C., Suite 500, 1101 14 Street, N.W., Washington, DC, 20005, US

(21) Appl. No.: 10/980,318

(22) Filed: Nov. 4, 2004

(51) Int. Cl. G06F 17/30

(52) U.S. Cl. 705/10

(57) ABSTRACT

A method of approving a new supplier is disclosed, which is used in an electronic dealing system (EDS) having an operating interface of a web page. At first, fields in a questionnaire are inputted and a plurality of electronic examination documents by a supplier candidate is uploaded. In response to the questionnaire received, the EDS assigns a general evaluation staff to perform an examination over qualifications of the supplier candidate. Next, the EDS assigns a plurality of evaluation staffs to evaluate a plurality of evaluation items corresponding thereto. Finally, an evaluation report is generated based on a total evaluation score obtained according to a plurality of evaluation scores in the plurality of evaluation items and their corresponding weights.

### BACKGROUND OF THE INVENTION

1. Field of Invention

The present invention is related to a method of processing information, and particularly to a method of approving a new supplier based on an evaluation report generated according to a total evaluation score obtained from a plurality of evaluation scores given by a plurality of evaluation staffs assigned by an electronic dealing system (EDS) corresponding to a plurality of evaluation items.

2. Related Art

In a manufacturing company, a new supplier providing a component used in its products often needs to be approved by the quality assurance department and the purchasing department. The quality assurance department selects a new supplier mainly based on the quality requirement for the component, while the purchasing department selects a new supplier based on the needed cost for the component. However, no matter how a new supplier is generated, all candidates for the new supplier must be subjected to an examination and evaluation process in each supplier-approval case so that it can be assured that the approved supplier meets all qualifications in production, quality assurance, environment protection and the like. Only after passing the examination and evaluation process, will the candidate become the approved supplier.

Generally, a supplier having passed an evaluation process is referred to as an AVL supplier. In a conventional process, when an new supplier desires to apply for an AVL supplier of a company, the new supplier have to fill out some application forms, i.e., application documents and examination documents, e.g., a license of the supplier, an ISO certificate, a company organization chart, a factory registration document, a quality assurance organization chart and the like in the application process. These written documents provided by the new supplier are generally sent to the company by mailing or expressage through a post office or the like, which is proved to be at a losing risk and not certain in the time reached at the company. Not only whether the company has received the documents can not be immediately ascertained, but also the written documents are hard to be maintained and stored.

When the application form from the new supplier is received, the company will assign a general evaluation staff to do a preliminary examination over qualifications of the new supplier. If necessary, the company even assigns evaluation staffs to the new supplier to make a further evaluation. Generally, the assigned evaluation staffs are from an assortment of departments, such as department of quality assurance, purchasing department, department of research and development, department of safety and sanitary and the like. These staffs from different departments are assigned to take care of different evaluation items over the new supplier according to their working contents, wherein the evaluation items may comprise management of quality assurance, management of business, management of research and development, management of environment and the like. After the evaluation process in the new supplier side is done, the evaluation staffs each have to give scores according to their evaluation results on an evaluation list. Since the evaluation list is needed to be transmitted among these evaluation staffs, it takes a relatively long time to obtain all the evaluation scores. Even worse, the evaluation list will be sometimes seriously delayed at some staff's hand and is not easy to be tracked and thus the whole scores may not be acquired in a short time.

Afterwards, an evaluation report has to be generated as a final evaluation result according to these evaluation scores in terms of the specific evaluation items. If it is the case that the supplier has an oversea company, then the company needs to have its staffs travel to the oversea company for the evaluation job and the related documents needs to be transmitted between two countries, which leads to a further longer processing time and thus a higher cost in obtaining the evaluation result.

### SUMMARY OF THE INVENTION

In view of the fact that electronic operating and electronic business have been introduced into an enterprise or between several enterprises, it is envisaged that an approval process for a new supplier may be improved by such electronic methods. That is, the conventional application manner for being an AVL supplier of a company based on written documents may be improved by utilizing electronic versions of the prior written documents. As such, the time-consuming and document storage issues encountered in the prior application manner may be addressed. Through an operation on an electronic network, each of a plurality of evaluation staffs may input an evaluation score simultaneously on a web page and an electronic dealing system (EDS) may generate an evaluation report according the evaluation scores. In addition, the evaluation scores may be viewed by the supplier candidate at any time so that the whole evaluation process may be transparent to the new supplier. Further, the general evaluation staff may track the evaluation process by monitoring the web page provided by the EDS. When an evaluation item has not been inputted with a score, the EDS issues a notification to the evaluation staff corresponding thereto. Besides, a country-crossing evaluation job may be conducted with such EDS. For instance, assuming that a new supplier having a subsidiary in America desires to be put on the approved vendor list of a company, the company may assign evaluation staffs in its America branch to conduct the evaluation task and the staffs may transmit back their evaluation scores through the network. Then, the EDS generates a total score based on the weights and the evaluation scores corresponding to the evaluation items. Thus an evaluation result and an evaluation report are accomplished and the time spent in the evaluation process may be shorten.

To achieve the above-mentioned purpose, the present invention provides a method of approving a new supplier applied in an electronic dealing system (EDS). The method for approving a new supplier mainly comprises an application process and an evaluation process. In the application process, a new supplier logins on an EDS and then enters a first web page, having one or more application pages, provided by a company to which the new supplier desires to provide a component. Then, the new supplier fills out and submits a questionnaire presented in the web page and uploads examination documents with an electronic form to the EDS. The step of filling out the application forms comprises a plurality of sub-steps, and each sub-step thereof should be done. After the last sub-step is performed, the filled questionnaire is submitted to a new supplier terminal in the EDS. In the evaluation process, a general evaluation staff is assigned by the new supplier terminal to perform an examination of qualifications for the new supplier. In the examination of qualifications, the general evaluation staff examines if the submitted questionnaire has been properly filled and if the required electronic examination documents have been uploaded, such as application documents and examination documents, e.g., a license of the supplier, an ISO certificate, a factory registration document, a company organization chart, a quality assurance organization and the like. As a matter of fact, the evaluation task may be assigned to at least one staff for each evaluation item and the assignment may be decided based on a random assignment scheme, an in-shift assignment scheme, a geographical site-based scheme or the like. After the evaluation staffs finish their evaluation tasks towards the new supplier, they input their evaluation scores with respect to the particular evaluation items in the EDS. Successively, the EDS generates an evaluation report (qualified or disqualified) according to an evaluation result having a general comment based on a total score obtained according to the evaluation scores to the evaluation items and the corresponding weights.

Hereinafter, the preferred embodiments according to the present invention will be described in detail as follows with reference to the accompanying drawings.

### BRIEF DESCRIPTION OF THE DRAWINGS

The invention will become more fully understood from the detailed description given hereinbelow illustration only, and thus are not limitative of the present invention, and wherein:

FIG. 1 is an illustration of a networking architecture in which a method of approving a new supplier of a preferred embodiment according to the present invention is applied;

FIG. 2 is an illustration of a flow chart of the method for approving a new supplier of the preferred embodiment according to the present invention; and

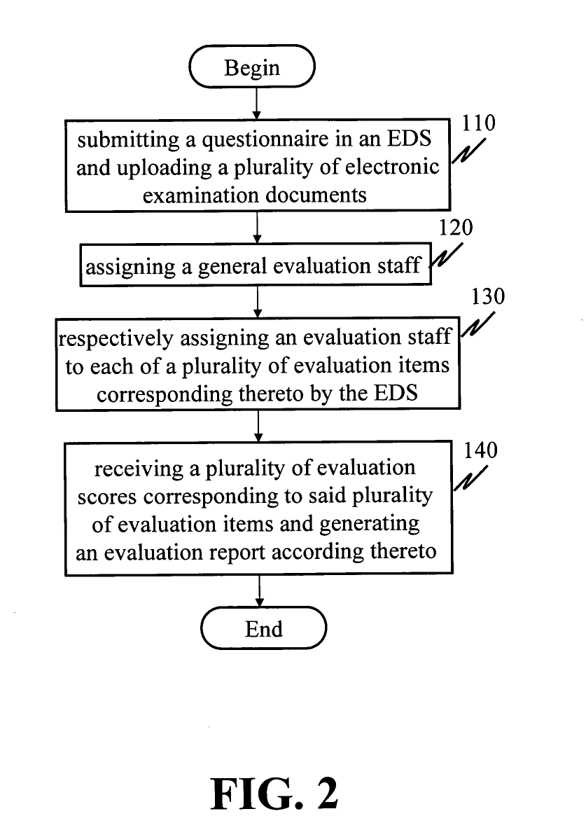

FIGS. 3A and 3B show a schematic questionnaire used in the method of approving a new supplier of the preferred embodiment according to the present invention.

### DETAILED DESCRIPTION OF THE INVENTION

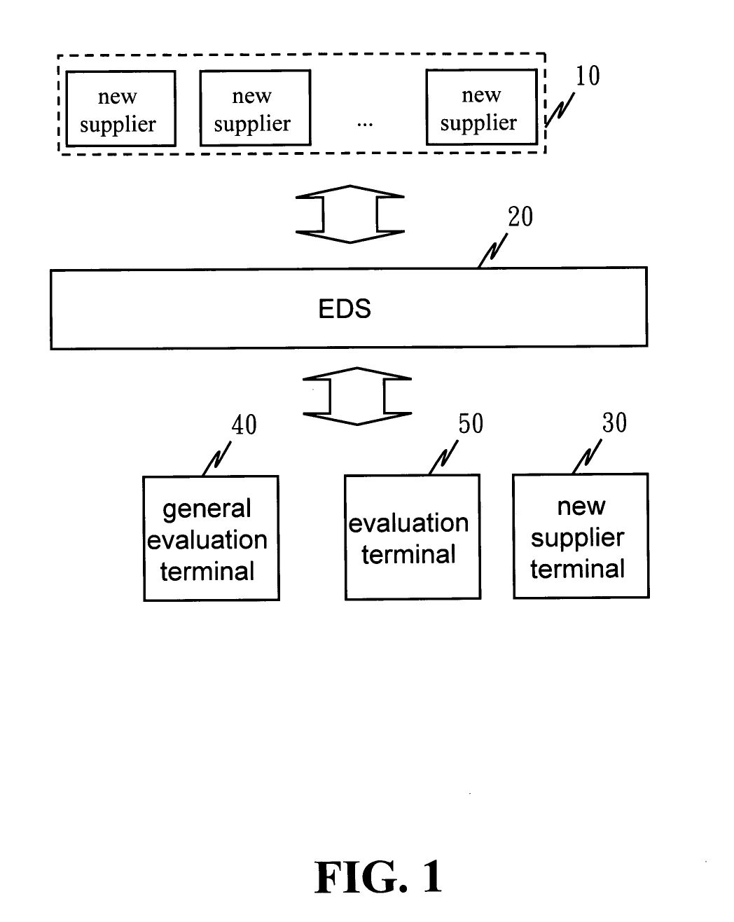

FIG. 1 is an illustration of a networking environment in which a method of approving a new supplier of an embodiment according to the present invention is implemented. Referring to FIG. 1, the networking environment associated with the method according to the present invention comprises an electronic dealing system (EDS) 20 embedded in a server computer coupled with a plurality of client computers through an electronic network such as the Internet. The server computer transmits an input interface and a query interface to the client computers and the two interfaces are both presented in a web page form. The client computer comprises a supplier terminal 10, a new supplier terminal 30, a general comment terminal 40 and an evaluation terminal 50. In the client computers, each has a browser, e.g. Microsoft Internet Explorer and Netscape Navigator, executed therein and used to couple with the EDS 20. In order to enter the EDS 20, each of the client computers has to input the correct login information, such as an account and a password corresponding thereto. According to the account inputted, a corresponding operating limit of authority is arranged and a corresponding first web page is displayed to the client computer. Next, the pre-steps of a method of approving a new supplier according to the present invention are illustrated, which are executed to acquire an account and a password corresponding thereto for accessing the EDS. In order to apply for a AVL supplier of the company providing the EDS, the supplier having not been acknowledged by the company (abbreviated as a new supplier) may couple to the EDS through the Internet and select or click an icon for applying for an account in the EDS. Then, the new supplier is presented with a web page that the new supplier may apply for logining information access for the EDS, such as the account and the password corresponding thereto. At this time, the new supplier inputs its basic information, such as the company name, the business registration number, the undertaker, the address, the telephone number and the like. Then, the information associated with the account is directed to an authorization interface of the company, which is generally the purchasing department. In response to the information associated with the account, the authorization interface sends logining information, such as the account and the corresponding password or the same for only basic limit of authority and a vendor code to the new supplier through a safe channel, e.g. by sending in person or a safe mechanism, e.g. by encryption and electronic signature. In addition, the new supplier may maintain the logining information such as making a change over the password from the issued password (default password) to a self-built password.

Next, a method of approving a new supplier of a preferred embodiment according to the present invention will be described in the following. When the logining information is obtained, the new supplier may login the EDS to apply for an actual supplier (AVL) through a process embedded in the EDS. In the embodiment, the new supplier first fills out and submits a questionnaire and then uploads a plurality of electronic examination documents as required (step 110). In the filling of the questionnaire, a multiple of steps are included and each corresponds to a field among a plurality of fields in the questionnaire. Only after all the fields appeared in the questionnaire are filled, will the next step be proceeded. The electronic examination documents (or with an enclosure attached) needed to be uploaded comprises an electronic examination document (or along with some certifications), such as a license of the supplier, an ISO certificate, a factory registration document, a company organization chart, a quality assurance organization chart and the like.

In the method of approving a new supplier, after the new supplier submits the required questionnaire, the EDS produces an application number which is later passed to a new supplier terminal (typically an administrator of the department of quality assurance). According to the application number, the new supplier terminal enters a staff-assignment web page and the EDS presets an evaluation staff and transmits the application number to the general evaluation staff (step 120), wherein the presetting of the general evaluation staff may be based on a random assignment, an in-shift assignment or the like. Alternatively, a general evaluation staff may be chosen from an employee library built in the company and then the chosen general evaluation staff is added to a staff candidate list (a pre-choosing step). In addition, the new supplier terminal may also change the staff candidate list, i.e., add or delete a staff candidate in the list (a re-choosing step).

Next, the general evaluation staff makes an evaluation over qualifications of the new supplier. First, the evaluation staff logins the EDS to check up if all fields in the submitted questionnaire have been filled out and if the required examination documents have been uploaded. After the checking operation, a step of clicking an icon “qualified” icon or an icon “disqualified” is executed according to the checking result. If the icon “qualified” is clicked, the general comment terminal may enter a staff assignment related webpage (same as step 120), in which the general comment terminal assigns at least one staff to each evaluation item among all the evaluation items (step 130) and in which staffs from different departments may be assigned to different evaluation items according to the relationship of their working contents and the evaluation items.

Thereafter, the general evaluation staffs go to the factory of the new supplier in person to make evaluations each based on their assigned evaluation items. After the evaluation-in-person is finished, each evaluation score corresponding to the corresponding evaluation item is inputted into the EDS through the evaluation terminal therein. In an actual practice, each of the evaluation scores is inputted into a corresponding field in a list provided by the EDS according to a serial number of the evaluation task. Since the limit of authority for each evaluation staff is predetermined in the EDS, the evaluation staffs may not input or change the evaluation scores in evaluation items they have not been assigned to. In addition, each field in the list should be inputted with a proper value and each evaluation item is designated a weight.

In the case where the new supplier has an oversea subsidiary, the company may not assign staffs to the oversea subsidiary for evaluation tasks but may otherwise assign staffs in the branch in the same country to conduct these evaluation tasks. Similarly, the staffs assigned in that country input their corresponding evaluation scores. Therefore, the purpose of a country-crossing evaluation process may be achieved.

The evaluation scores may be monitored or tracked by any evaluation staff to see if all evaluation scores have been inputted. If any evaluation score is not presented in the list, any of the other evaluation staffs may send a message, such as in an email form, prompting the relevant evaluation staff to input his evaluation score as soon as possible.

In response to all the evaluation scores received, the EDS generates an evaluation report based on a total score according to the evaluation scores and their corresponding weights to determine if the new supplier is qualified (step 140). Based on the total score, the new supplier may be given an evaluation grade, such as grade A, grade B and grade C, or a ranking, which is also included in the evaluation report.

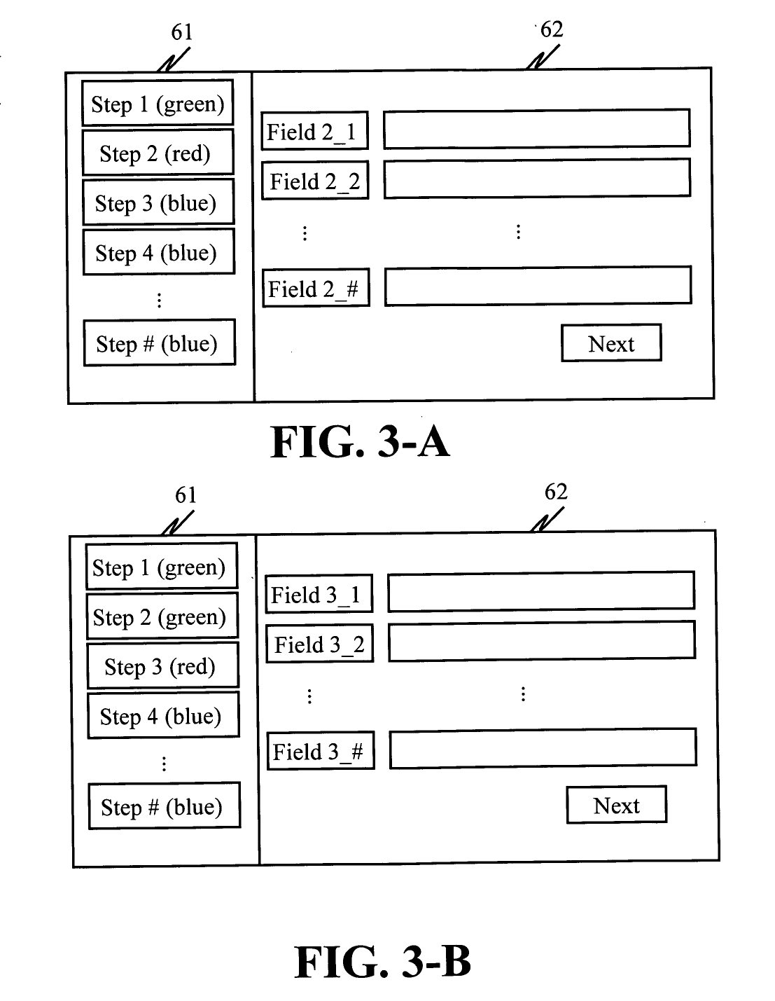

FIGS. 3A-B show a schematic diagram of a questionnaire used in the method of approving a new supplier according to the present invention. As shown in FIG. 3A, the questionnaire is presented on a display of the client computer in a window divided form and has at least an indicator window 61 and a display window 62. The indicator window 61 displays a plurality of steps presented in different colors to represent the finished step(s), the current step and the unfinished step(s). For example, green color is used to represent the finished step(s), red color is used to represent the current step and blue color is used to represent the unfinished step(s). Each of the steps has a corresponding frame shown in the display window 62 for showing the corresponding field to be inputted. Also, each of the steps is proceeded by order, i.e., a step will be executed only after its proceeding step is finished.

For example, if the current step is “Step 2”, the “Step 1” shown in the indicator window 61 is displayed as green color, then the “Step 2” is displayed as red color and the “step 3” is displayed as blue color. In this case, the display window 62 shows at the same time a frame to be inputted corresponding to the “Step 2” in the indicator window 61. In the frame of the display window 62, there also includes an icon “to the Next Step” icon. The icon “to the Next Step” may be clicked successfully only after every field in the current frame of the display window 62 is inputted. As shown in FIG. 3B, when the icon “to the Next Step” is clicked, the “Step 2” in the indicator window 61 turns from red to green and information in every fields in the display window 62 is stored, and the “Step 3” in the indicator window 61 turns from blue to red and calls a web page corresponding to “Step 3” to be presented in the display window 62.

When any step in the indicator window 61 is needed to be corrected, the “Step 1” (the finished step) in the indicator window 61 may be clicked and then it turns from green to red and the web page corresponding to the “Step 1” is displayed in the display window 62. At this time, all the fields previously inputted corresponding to the “Step 1” will be presented and the presented contents in these fields may be corrected. However, if the “Step 4” in the indicator window 62 is clicked (the unfinished step), no reaction will occur in the current frame since each step should be executed in an order.

In addition, the fields in the display window 62 are classified as a main field group and a check-up field group with different colors. If any main field or check-up field, such as a field of email, telephone number or the like is not properly inputted, the icon “to the Next Step” may not be clicked and a message block will show to inform the manipulator, e.g. the new supplier, to input pertinent information. In the indicator window 61, the web page corresponding to the last step presents an icon “Finish” rather than the icon “to the Next Step” mentioned above. Upon the icon “Finish” is clicked, the whole information in the fields is stored in a database in the EDS. The new supplier may not change or modify the information inputted prior to an evaluation report generated.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A method of approving a new supplier by evaluating said new supplier through an electronic dealing system (EDS) having a web page as an operating interface, comprising the steps of:
submitting a questionnaire in said EDS and uploading a plurality of electronic examination documents;
assigning a general evaluation staff and transmitting said questionnaire to said general evaluation staff by said EDS;
respectively assigning an evaluation staff to each of a plurality of evaluation items corresponding thereto by said EDS; and
receiving a plurality of evaluation scores corresponding to said plurality of evaluation items and generating an evaluation report based thereon.

2. The method as recited in claim 1, further comprising a step of logining said EDS to verify logining information and display a web page corresponding thereto.

3. The method as recited in claim 1, further comprising a step of examining a qualification of said new supplier to see if said questionnaire has been totally filled out and if said plurality of electronic examination documents have been totally uploaded.

4. The method as recited in claim 1, wherein said questionnaire comprises an indicator window comprising a plurality of blocks each reciting a guiding step and a display window displaying one of a plurality of web pages corresponding to one of said guiding steps recited in said plurality of blocks.

5. The method as recited in claim 4, wherein said plurality of guiding steps recited in said plurality of blocks is executed by an order.

6. The method as recited in claim 4, wherein said plurality of guiding steps are presented with different colors to respectively represent finished step(s), a current step and unfinished step(s).

7. The method as recited in claim 1, wherein said plurality of evaluation scores are inputted into said EDS by said evaluation staffs corresponding to said plurality of evaluation items.

8. The method as recited in claim 1, wherein each of said evaluation items has a weight and a total score is obtained according to said plurality of evaluation scores and said plurality of weights.

9. The method as recited in claim 1, wherein said plurality of examination documents comprises a company license, a factory registration document, an ISO certificate, a company organization chart and a quality assurance organization chart.
